(19) United States
(12) Patent Application Publication
(10) Pub. No.: US 2019/0359014 A1
(43) Pub. Date: Nov. 28, 2019

(54) MULTI-CHAMBERED WHEEL ASSEMBLY FOR RAPID TIRE INFLATION

(71) Applicant: Bridgestone Americas Tire Operations, LLC, Nashville, TN (US)

(72) Inventors: Benjamin R. Rethmel, Rittman, OH (US); Samuel O. Givens, Copley, OH (US); Anthony B. Duncan, Akron, OH (US)

(21) Appl. No.: 16/478,167

(22) PCT Filed: Jan. 16, 2018
(86) PCT No.: PCT/US18/13758

§ 371 Date: Jul. 16, 2019

Related U.S. Application Data
(60) Provisional application No. 62/449,671, filed on Jan. 24, 2017.

(51) Int. Cl. B60C 23/00; B60B 21/12; B60C 23/04; B60C 5/00; B60B 21/10

(52) U.S. Cl. CPC B60C 23/009; B60B 21/12; B60C 23/002; B60C 23/003; B60C 2200/08; B60C 23/04; B60C 5/002; B60C 5/004; B60B 21/10; B60C 23/004

(57) ABSTRACT

A multi-chambered wheel assembly may include a wheel rim and a tire mounted on the wheel rim. The tire and the wheel rim may define an interior chamber. A divider wall may be disposed in the interior chamber. The divider wall may define a fill chamber and a gas cavity. A gas valve may be communicated with the gas cavity. The gas valve may be configured to allow pressurized gas to be introduced into the gas cavity. A fill valve may be communicated with the fill chamber. The fill valve may be configured to allow fill material to be introduced into the fill chamber.

### BACKGROUND

The present disclosure relates generally to a method and apparatus for adjusting gas pressure within a tire. More particularly, the method and apparatus provide for the rapid change between a field ready pressure and a road ready pressure for large agricultural tires when the corresponding agricultural vehicles move from a field environment to a road environment and vice versa.

Large self-propelled agricultural equipment such as a tractor, combine harvester, or high clearance sprayer spends most of its operational time in or around a cultivated field. As a result, the tires of the equipment are often adapted to address common concerns arising from using heavy machinery over a cultivated field. One of the common concerns is soil compaction. As large equipment travels over a given field, the soil beneath the equipment's tires will be compacted and suffer an increased density. This soil compaction may be harmful to the production or yield of the field. As soil compaction increases, the yield will often decrease. In order to combat this problem, it is common for equipment operators to reduce the gas pressure of the tires when the equipment is in the field. Experience has shown that a reduced tire gas pressure can reduce the level of soil compaction in the field. As a result, it can also increase the production and efficiency of the field.

While this reduced tire gas pressure may be preferable in the field environment, an elevated tire pressure is still preferable when the equipment is traveling over a typical paved road. The elevated tire pressure allows each tire to roll more efficiently and achieve a higher maximum velocity. With many users being forced to transport their large agricultural equipment extended distances from one field to another, speed and efficiency during transport is important. However, the time needed to inflate or deflate a typical tire is often a hindrance to the ability to rapidly and efficiently move the agricultural equipment from the field environment to the road environment.

On-board tire inflation systems on vehicles (agricultural tractors specifically) must provide inflation air to the controlled tires in order to increase their inflation pressure. Conversely, they must also release air in order to decrease inflation pressure. The amount of air that needs to be supplied/released is dependent on the intended change in pressure and on the internal volume of the controlled tires. Large tires require a large volume of air and, thus, a large air compressor to supply the air in a reasonable amount of time. If the internal volume of the tire cavity could be reduced, the amount of air transferred would be reduced, and the time required would also be reduced. Additionally or alternatively, a smaller compressor could be used.

What is needed, then, is an improved tire inflation system addressing at least one of these concerns.

### BRIEF SUMMARY

Briefly, the present disclosure relates, in one embodiment, to a multi-chambered wheel assembly. The wheel assembly may include a wheel rim and a tire mounted on the wheel rim. The tire and the wheel rim may define an interior chamber. A divider wall may be disposed in the interior chamber. The divider wall may define a fill chamber and a gas cavity. A gas valve may be communicated with the gas cavity. The gas valve may be configured to allow pressurized gas to be introduced into the gas cavity. A fill valve may be communicated with the fill chamber. The fill valve may be configured to allow fill material to be introduced into the fill chamber.

An alternative embodiment may include the fill chamber being at least partially filled with a non-compressible fill material.

Still another embodiment includes the non-compressible fill material including a foam.

Yet another embodiment includes the non-compressible fill material including water.

Another embodiment includes the non-compressible fill material including solid pellets.

A further embodiment includes the fill chamber having a maximum fill chamber height when the fill chamber is at least partially filled with the non-compressible fill material. The maximum fill chamber height may extend beyond the wheel rim in a radial direction such that the wheel assembly may include run-flat capabilities.

A further still embodiment includes the divider wall including an inner tube sized for a tire smaller than the tire mounted on the wheel rim.

Yet another embodiment includes the divider wall being substantially rigid.

Still another embodiment includes the multi-chambered wheel assembly in combination with an onboard inflation system for a vehicle having a plurality of multi-chambered wheel assemblies.

An even further embodiment includes the onboard inflation system including at least one compressor configured to pump gas into the gas cavity of at least one of the plurality of multi-chambered wheel assemblies.

Another embodiment includes a release valve configured to vent gas out of the gas cavity so that operating pressure in the gas cavity of each of the plurality of multi-chambered wheel assemblies can be lowered.

One embodiment includes the onboard inflation system further including a controller. The controller may be configured to selectively control the at least one compressor to repeatedly change operating pressure in the gas cavity of at least one of the plurality of multi-chambered wheel assemblies between a lower inflation pressure and a higher inflation pressure.

A further embodiment includes the controller further configured to selectively control the gas valve of at least one of the plurality of multi-chambered wheel assemblies.

The present disclosure also relates, in one embodiment, to a method of controlling inflation pressures of a plurality of tires mounted on a plurality of wheel rims of a vehicle. Each tire may be mounted on a respective wheel rim to define a wheel assembly. The method may include providing each wheel assembly with a fill chamber disposed in an interior chamber. Each interior chamber may be defined by the tire and wheel rim of each respective wheel assembly. A gas cavity may be operatively located in the interior chamber adjacent a tread portion of the tire. The method may further include providing a compressor configured to introduce gas into the gas cavity of each respective wheel assembly. The method may also include at least partially filling each fill chamber with a non-compressible fill material through a respective fill valve. The method may include providing each gas cavity with an initial inflation pressure greater than atmospheric pressure. The method may even further include selectively operating the compressor to increase pressure in the gas cavity of each respective wheel assembly by pumping gas into the gas cavity through a gas valve. The pressure may more rapidly be increased compared to what the compressor could do if each respective wheel assembly did not include the interior chamber partially occupied by the fill chamber at least partially filled with the non-compressible fill material.

A further embodiment includes selectively venting at least one wheel assembly to allow gas to escape the associated gas cavity to decrease pressure in the gas cavity. The pressure may more rapidly be decreased compared to what is possible if each respective wheel assembly did not include the interior chamber partially occupied by the fill chamber at least partially filled with the non-compressible fill material.

Another embodiment includes the step of selectively operating the compressor to increase the pressure in the gas cavity of each wheel assembly being performed by an automatic controller in response to an operator input.

Still another embodiment may include removing at least some of the non-compressible fill material from the fill chamber through the fill valve of the wheel assembly. The method may further include removing the tire from the wheel rim for service or replacement.

### BRIEF DESCRIPTION OF THE DRAWINGS

FIG. 1 is a schematic plan view of an agricultural vehicle including a tractor and an implement pulled by the tractor outfitted with an embodiment of a wheel assembly and corresponding rapid inflation system.

FIG. 2 is a schematic side elevation view of the tractor of FIG. 1.

FIG. 3 is a schematic side elevation view of a tractor outfitted with an alternative embodiment of a wheel assembly and corresponding rapid inflation system.

FIG. 4 is a schematic cross-sectional view of the wheel assembly of the tractor of FIG. 1, the implement of FIG. 1, or the tractor of FIG. 3.

FIG. 5 is a schematic cross-sectional view of an alternative embodiment of a wheel assembly.

FIG. 6 is a schematic view of an embodiment of the wheel assembly and rapid inflation system of FIG. 1.

FIG. 7 is a schematic view, similar to that portion of FIG. 6 contained in dashed lines, illustrating an alternative embodiment of the wheel assembly and rapid inflation system.

FIG. 8 is a schematic illustration of the controller and its interconnection with the various components of the wheel assembly and rapid inflation system of FIG. 6.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

“Signal” may include any meaning as may be understood by those of ordinary skill in the art, including at least an electric or magnetic representation of current, voltage, charge, temperature, data, or a state of one or more memory locations as expressed on one or more transmission mediums, and generally capable of being transmitted, received, stored, compared, combined, or otherwise manipulated in any equivalent manner.

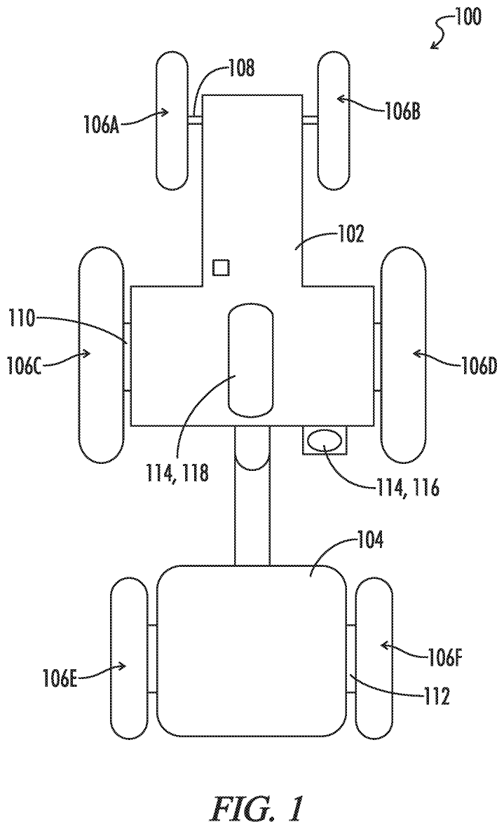

Referring to FIGS. 1-3, a vehicle 100 is shown which may include a tractor 102 and a trailer 104. The trailer 104 may be a trailer for hauling goods, or it may be another agricultural implement including, but not limited to, freewheeling agricultural implements including corn planters, tillage equipment, disc implements, rippers, field cultivators, air seeders, and the like.

The tractor 102 may include first and second front wheel assemblies 106A, 106B associated with a front axle 108. The tractor 102 may also include first and second rear wheel assemblies 106C, 106D associated with a rear axle 110. The trailer 104 may include first and second trailer wheel assemblies 106E, 106F associated with a trailer axle 112. Any appropriate number of wheel assemblies and axles are contemplated for both the tractor 102 and the trailer 104. The vehicle 100 may include other arrangements and may include more, or fewer, than the six wheel assemblies shown.

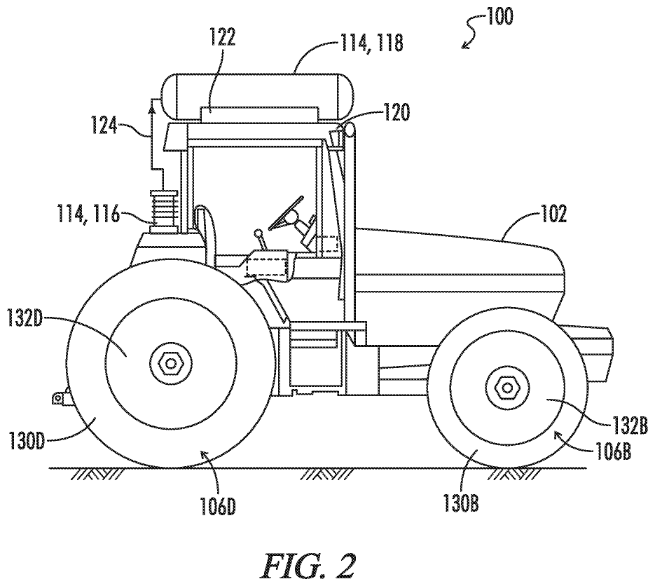

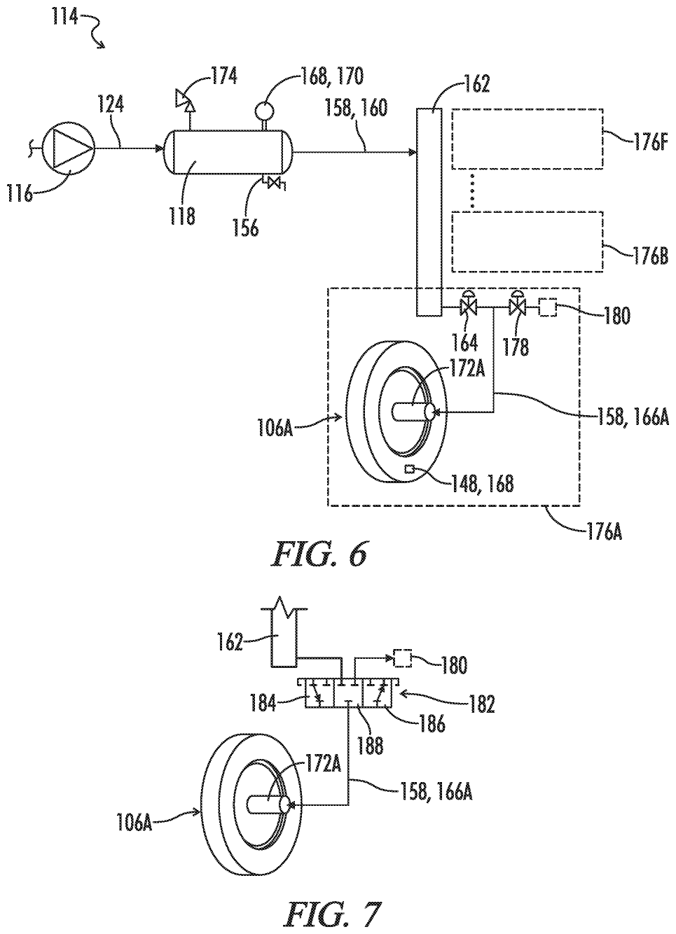

An onboard inflation system 114 may be mounted on the vehicle 100 and is schematically illustrated in FIG. 6. The inflation system 114 may include a compressor 116 carried on the tractor 102. A gas storage tank 118 may also be carried on the tractor 102. As best seen in FIG. 2, the gas storage tank 118 may be mounted on a roof 120 of the tractor 102 in any appropriate manner. In one embodiment, the gas storage tank 118 may be mounted on the roof 120 with at least one mounting bracket 122. A compressed gas supply line 124 may communicate the compressor 116 with the gas storage tank 118.

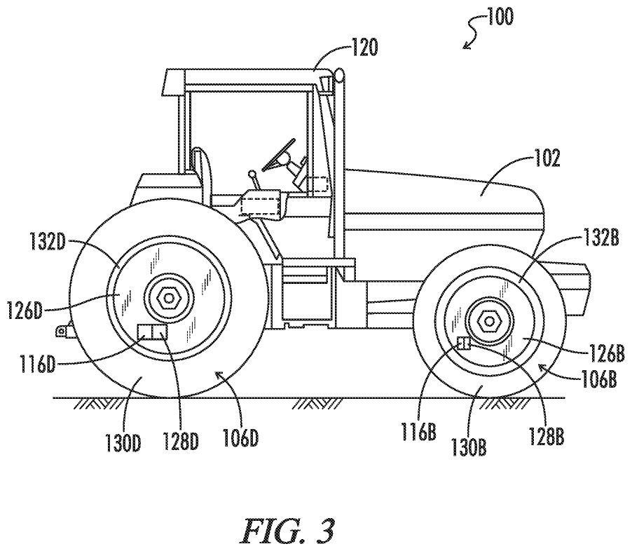

In FIG. 3, an alternative embodiment is schematically illustrated, in which external gas storage chambers 126B, 126D are carried on or mounted on their associated respective wheel assemblies 106B, 106D. Compressors 116B, 116D and corresponding valves 128B, 128D may also be carried by their respective wheels 106B, 106D to rotate with the wheels.

Regardless of the embodiment, the compressor(s) 116, 116A-F may be electrically powered via batteries, by hydraulic or pneumatic power, or by hard wired electrical power. For the embodiment shown in FIG. 3, the power connections may be rotating connections from a power source located elsewhere on the vehicle 100.

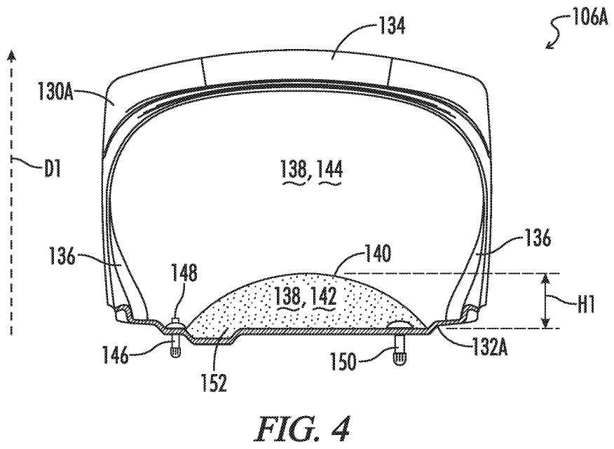

Turning now to FIG. 4, each wheel assembly 106A-F may include a tire 130A-F mounted on an associated wheel rim 132A-F such as the wheel assembly 106A shown. The tire 130A may include a tread portion 134 and two sidewalls 136. The tire 130A and its corresponding wheel rim 132A may together define an interior chamber 138.

In the embodiment shown in FIG. 4, a divider wall 140 separates the interior chamber 138 into a fill chamber 142 and a gas cavity 144. In some embodiments, the fill chamber 142 is generally between the wheel rim 132A and the divider wall 140, and the gas cavity 144 is generally between the divider wall and the tread portion 134. The divider wall 140 may be an annular sheet-like member or a toroidal bladder which encloses the fill chamber 142. Any of the embodiments of the divider wall 140 may have the divider wall constructed of one or more plies of rubber coated parallel cords. If multiple layers are utilized, the layers are preferably oriented in the manner of bias plies with cords of alternating layers running in alternating directions. Additionally, the divider wall 140 may be made of any other suitable materials. The divider wall 140, in some embodiments, may include an inner tube that is sized for a tire that is smaller than the tire 130A mounted on the corresponding wheel rim 132A. Other embodiments may include the divider wall 140 being substantially rigid. The divider wall 140 may, in further embodiments, be a multi-segmented piece that may include individual fill chambers 142 that may be linked together if desired. The divider wall 140 may also be a series of individual fill chambers 142 that are completely separate from each other. These separate fill chambers 142 may be oriented such that each separate fill chamber runs about the tire annularly or such that each separate fill chamber occupies a portion of the circumference of the wheel assembly 106A-F and extends in an axial direction of the wheel assembly. Each fill chamber 142 may have its own fill valve 150, or each fill chamber may be communicated with a fill valve that is common to all the fill chambers.

A gas valve 146 may be communicated with the gas cavity 144. The gas valve 146 may be configured to allow pressurized gas, such as from gas storage tank 118 and/or compressor 116, to be introduced into the gas cavity 144. The gas valve 146 may be any appropriate valve, including a Tire Pressure Monitoring System (TPMS) valve having at least one pressure sensor 148 disposed in the gas cavity 144. The pressure sensor 148 may be mounted in any appropriate location that allows for communication with the gas cavity 144.

A fill valve 150 may be communicated with the fill chamber 142. The fill valve 150 may be configured to allow fill material 152 to be introduced into the fill chamber 142. The fill material 152 may at least partially fill the fill chamber 142. Many embodiments may include the fill material 152 being non-compressible. Some embodiments include the non-compressible fill material 152 including a foam. The foam may be any appropriate material, but at least one embodiment of the foam may be understood to be a liquid expanding foam. This liquid expanding foam could be injected through the fill valve 150 in a liquid form. Once disposed in the fill chamber 142, the liquid could expand into a foam. In some embodiments, the foam may then harden and become a permanent or semi-permanent structure inside the fill chamber 142. Another embodiment may include the fill material 152 pre-applied to the inside of the fill chamber 142, such as on the divider wall 140. In this embodiment, an activator, or catalyst, may be injected into the fill chamber 142 via the fill valve 150 instead of the fill material 152. The catalyst may activate the fill material 152 such that it rapidly expands and/or hardens to at least partially fill the fill chamber 142. Other embodiments include the non-compressible fill material 152 including water. Still other embodiments include the non-compressible fill material 152 including solid pellets of an appropriate manufacture. The fill valve 150 may be sized, and of the appropriate configuration, for the corresponding fill material 152. When the fill chamber 142 is at least partially filled with the non-compressible fill material 152, some embodiments include the fill chamber having a maximum fill chamber height H1 that extends beyond the wheel rim in a radial direction D1. The wheel assembly 106A may have run-flat capabilities in these embodiments. In any embodiment, the amount of fill material 152 supplied to the fill chamber 142 may be varied such that the overall volume of the fill chamber may be controlled and specified relative to the overall volume of the gas cavity 144.

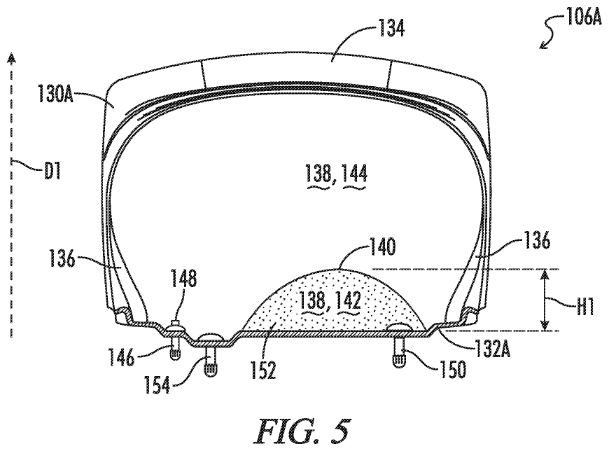

As shown in FIG. 5, an alternative embodiment of the wheel assembly 106A may further include a release valve 154. The release valve 154 may be configured to vent gas out of the gas cavity 144 so that the operating pressure in the gas cavity of the respective wheel assembly 106A can be lowered. The configuration of FIG. 5 may be beneficial if a user wishes to leave the compressor 116 fluidly coupled to the gas valve 146. In such an embodiment, the divider wall 140 may be shaped differently or may be smaller than the embodiment shown in FIG. 4 so both the gas valve 146 and the release valve 154 may easily communicate with the gas cavity 144.

As shown in FIGS. 3-5, the wheel assemblies 106A-F may be combined with the onboard inflation system 114. The onboard inflation system 114 may be configured to alter the pressure in the gas cavity 144 of at least one wheel assembly 106A, but may also be configured to alter the pressure in the gas cavity of any appropriate number of the wheel assemblies 106A-F.

A condensate drain 156 may be provided on the gas storage tank 118 as shown in FIG. 6.

An inflation gas line 158 may communicate the gas storage tank 118 with the gas cavity 144 of at least one of the wheel assemblies 106A-F. Additionally or alternatively, the compressor 116 may be directly connected to at least one of the wheel assemblies 106A-F. In some embodiments, the inflation gas line 158 may include an inflation gas main line 160 which connects the gas storage tank 118 to a manifold 162.

In the embodiment illustrated in FIG. 6, the inflation gas main line 160 is illustrated as having one and only one tubular conduit communicating the gas storage tank 118 with the manifold 162. In some embodiments, the inflation gas main line 160 could comprise multiple tubular conduits communicating one or more gas storage tanks 118 with the manifold 162, or with multiple manifolds associated with the various components of at each wheel assembly 106A-F.

In some embodiments, a plurality of automatically operable gas valves 164 is connected to the manifold 162. The automatic gas valves 164 may be the gas valves 146 disposed on or in the wheel rim 132A of a corresponding wheel assembly 106A as shown in FIGS. 4 and 5, but some embodiments may alternatively or additionally include the automatic gas valves 164 being separate from the wheel assembly while still fluidly communicating with the gas cavity 144. In the embodiment shown in FIG. 6, each automatic gas valve 164 is communicated with a gas cavity 144 of a respective wheel assembly 106A-F by a separate inflation gas branch line 166A-F. The inflation gas branch lines 166A-F may be considered part of the inflation gas line 158.

An inflation pressure sensor 168 may be arranged to detect an inflation pressure provided to the at least one of the wheel assemblies 106A-F. The inflation pressure sensor 168 may be the pressure sensor 148 disposed in the gas cavity 144, but some embodiments may alternatively or additionally include the inflation pressure sensor 168 being outside the gas cavity while still communicated with the gas cavity, the gas storage tank 118, or the inflation gas main line 160. In at least one embodiment, the inflation pressure sensor 168 may include a tank pressure gauge 170. In embodiments including the inflation pressure sensor 168 being the pressure sensor 148 disposed in the gas cavity 144 of each of the wheel assemblies 106A-F, each pressure sensor 148 may be configured to wirelessly transmit the pressure data.

The inflation gas branch lines 166A-F may communicate gas to the gas cavity 144 of each associated respective wheel assembly 106A-F via rotary unions such as union 172A schematically illustrated in FIG. 6.

In some embodiments, the rotary union 172A of a respective wheel assembly 106A communicates with the gas cavity 144 via a pilot type inflation valve. Such valves communicate with two pneumatic circuits of the rotary union 172A. A large bore circuit provides a flow path for inflation gas, and a smaller bore circuit supplies pilot gas pressure to a pilot valve of the inflation valve. The pilot valve is located in the inflation valve and acts to separate the gas cavity from the outside. When the pilot circuit is unpressurized, the inflation valve is closed and the gas cannot leak from the gas cavity 144 through the inflation valve plumbing. Pressurizing the pilot valve of the inflation valve forces the inflation valve to open so that the tire cavity is connected to the inflation path through the rotary union 172A. An advantage of this arrangement is that the tire cannot leak due to damage to the pressure tubing and the rotary union 172A can remain unpressurized most of the time, thus improving seal life. Such pilot actuated inflation valves may be particularly useful when using internal TPMS sensors 148.

A pressure relief valve 174 may be mounted on the gas storage tank 118.

In the embodiment of FIG. 6, the details of the valving associated with the wheel assembly 106A are schematically illustrated within the dashed box 176A. The details associated with the valving corresponding to each of the other wheel assemblies 106B-F may be similarly constructed with regard to the other dashed boxes 176B-F. The automatic gas valve 164 communicates the gas cavity 144 of the associated wheel assembly 106A with the gas storage tank 118 when the automatic gas valve is in an open position. The automatic gas valve 164 may be a solenoid operated valve having an open position and a closed position. The automatic gas valve 164 may be described as a non-throttling on-off valve selectively moveable between a discrete open position and a discrete closed position.

As further illustrated in the embodiment of FIG. 6, an automatic release valve 178 may be associated with each wheel assembly 106A-F. In some embodiments, the automatic release valve 178 may be the release valve 154 disposed on or in the wheel rim 132A-F as shown in FIG. 5. Each of the automatic release valves 178 may also be a separate solenoid operated valve which may be described as a non-throttling on-off valve selectively moveable between a discrete open position and a discrete closed position. In the embodiment shown in FIG. 6, each of the automatic release valves 178 is connected to the associated inflation gas branch line 166A-F between its associated automatic gas valve 164 and the respective wheel assembly 106A-F. The automatic release valve 178 is also communicated with an open exhaust zone 180 which may, for example, be the atmosphere.

When the automatic gas valve 164 is open and the automatic release valve 178 is closed, compressed gas may be provided to the wheel assembly 106A to further inflate the gas cavity 144 from the compressed gas storage tank 118. To deflate the gas cavity 144, the automatic gas valve 164 is closed and the automatic release valve 178 is opened.

FIG. 7 shows an alternative embodiment wherein the contents of the dashed box 176 of FIG. 6 include a single three-way valve 182 instead of the arrangement of a separate automatic gas valve 164 and automatic release valve 178 described above regarding FIG. 6.

In FIG. 7, the three-way valve 182 is illustrated schematically as having an open position 184 in which the manifold 162 is communicated with the gas cavity 144, a release position 186 in which the respective gas cavity is vented to the open exhaust zone 180 to decrease inflation pressure in the gas cavity, and a blocked position 188 in which there is no flow of gas to or from the gas cavity through the three-way valve. This configuration may be provided in addition to or instead of the valves 146, 150 of FIG. 4 or the valves 146, 150, 154 of FIG. 5.

### The Control System

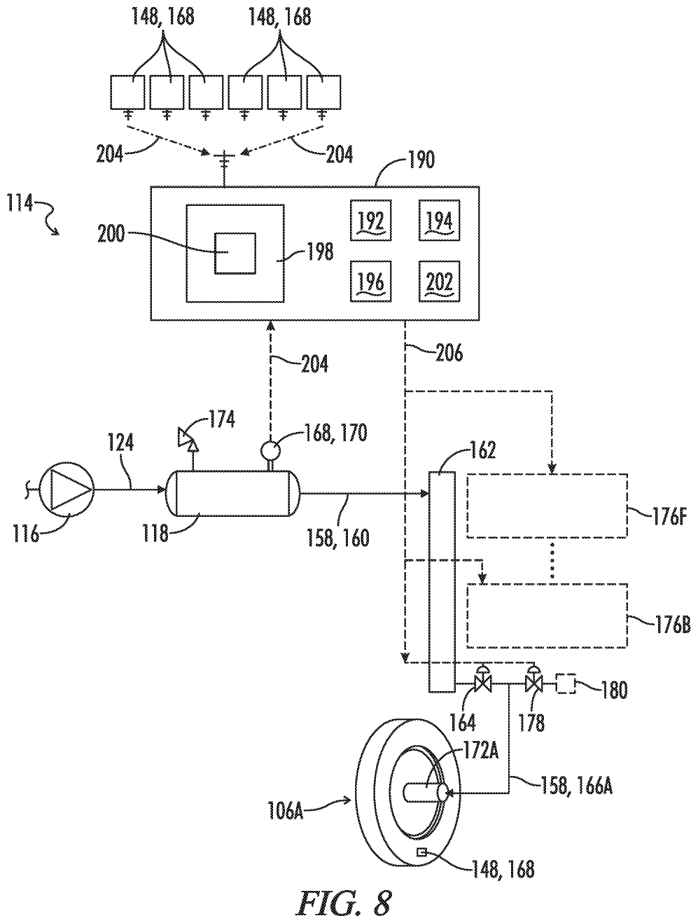

Referring now to FIG. 8, a control system for the onboard inflation system 114 is schematically illustrated. A controller 190 is operably associated with all of the automatic gas valves 164, the automatic release valves 178, and various other components of the onboard inflation system 114.

The controller 190 includes a processor 192, a computer readable memory medium 194, a data base 196, and an input-output module or control panel 198 having a display 200.

The term “computer readable memory medium” as used herein may refer to any non-transitory medium 194 alone or as one of a plurality of non-transitory memory media 194 within which is embodied a computer program product 202 that includes processor executable software, instructions, or program modules which, upon execution, may provide data or otherwise cause a computer system to implement subject matter or otherwise operate in a specific manner as further defined herein. It may further be understood that more than one type of memory media may be used in combination to conduct processor executable software, instructions, or program modules from a first memory medium upon which the software, instructions, or program modules initially reside to a processor for execution.

“Memory media” as generally used herein may further include without limitation transmission media and/or storage media.

“Storage media” may refer in an equivalent manner to volatile and non-volatile, removable and non-removable, media, including at least dynamic memory, application specific integrated circuits (ASIC), chip memory devices, optical or magnetic disk memory devices, flash memory devices, or any other medium which may be used to store data in a processor accessible manner, and may, unless otherwise stated, either reside on a single computing platform or be distributed across a plurality of such platforms.

“Transmission media” may include any tangible media effective to permit processor executable software, instructions, or program modules residing on the media to be read and executed by a processor, including, without limitation, wire, cable, fiber-optic, and wireless media such as is known in the art.

The term “processor” as used herein may refer to at least general purpose or specific purpose processing devices and/or logic as may be understood by one of skill in the art, including, but not limited to, singlethreading or multithreading processors, central processors, parent processors, graphical processors, media processors, and the like.

The controller 190 receives input data from the various sensors such as the inflation pressure sensor 168 and the various pressure sensors 148 disposed within the respective gas cavities 144, all of which are illustrated via dashed communication lines 204 as shown schematically in FIG. 8. The controller 190 may receive various other inputs regarding other operating parameters of the vehicle 100.

Based upon various operational modes which may be defined by the computer programming product 202, the controller 190 generates various control signals which may be communicated to the automatic gas valves 164, the automatic release valves 178, and various other components vas schematically illustrated via dashed communication lines 206. Any of the communication lines 204, 206 may be hard wired or may include wireless communication.

Depending on the user input desired pressure, which can be an input number or simply a designation by a user that the vehicle 100 is to be prepared to travel on either a field or a road, the controller 190 may receive the input data of the current pressure in the wheel assemblies 106A-F. The controller 190 may compare the desired pressure input by the user with the current pressure read by the various pressure sensors 148 and/or the inflation pressure sensor 168. If the desired pressure is higher than the current pressure, the controller 190 may keep the automatic release valves 178 closed and open the automatic gas valves 164 to inflate the one or more gas cavities 144. If the desired pressure is lower than the current pressure, the controller 190 may keep the automatic gas valves 164 shut and open the automatic release valves 178 to deflate the one or more gas cavities 144.

### Manual Embodiments

Many embodiments may include no controller 190 to automatically regulate the pressure in the respective gas cavities 144. These relatively simple embodiments may have the wheel assembly 106A-F construction as shown in either FIG. 4 or FIG. 5. In the simplest embodiments, the gas valve 146 and the fill valve 150 in FIG. 4 and the gas valve, fill valve, and release valve 154 in FIG. 5 may all be typical tire stem valves. Some embodiments may still include the pressure sensor 148 in each wheel assembly 106A-F that wirelessly transmits pressure readings to a controller for notification or monitoring purposes.

To use the embodiment shown in FIG. 4, a user may introduce fill material 152 into the fill chamber 142 via the fill valve 150. The at least partially filled fill chamber 142 reduces the amount of the interior chamber 138 that is occupied by the gas cavity 144, thereby allowing relatively fast pressure changes in the gas cavity. A user may then connect an inflation gas line 158 from a gas storage tank 118 or compressor 116 (which may be mounted to the tractor 102 or may be separate from the tractor) to the gas valve 146. The user may then fill the gas cavity 144 to the desired pressure if the current pressure is too low for the upcoming task, such as when the tractor 102 is about to begin driving on a road from a field. If the current pressure is too high for the upcoming task, such as when the tractor 102 is about to begin driving on the field from the road, the user may vent gas from the gas cavity 144 through the gas valve 146 through conventional methods.

Regarding the embodiment shown in FIG. 5, a user may perform all the same steps with regard to introducing fill material 152 into the fill chamber 142 and inflating the gas cavity 144. In this embodiment, however, a user may vent gas from the gas cavity 144 through the release valve 154. The release valve 154 may be of the same or different construction compared to the gas valve 146. The separate release valve 154 may be beneficial when a user desires to leave the inflation gas line 158 connected to the gas valve 146, such as when the gas storage tank 118 and/or compressor 116 are mounted to the tractor 102 or a given wheel assembly 106A-F. In some embodiments, the release valve 154 is configured to release gas from the gas cavity 144 faster than the gas valve 146.

If a user wishes to remove a tire 130A-F from a corresponding wheel rim 132A-F, the user may, in some embodiments, remove at least some of the non-compressible fill material 152 from the fill chamber 142 through the fill valve 150 of the given wheel assembly 106A-F. The tire 130A-F may then be more easily removed from the corresponding wheel rim 132A-F than would be the case if none of the fill material 152 were removed. In some embodiments including the fill material 152 having previously hardened or set, such as with the foam discussed above, an additive may be injected into the fill chamber 142 through the fill valve 150 to soften or dissolve the fill material for removal.

This written description uses examples to disclose the invention and also to enable any person skilled in the art to practice the invention, including making and using any devices or systems. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Although embodiments of the disclosure have been described using specific terms, such description is for illustrative purposes only. The words used are words of description rather than limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. While specific uses for the subject matter of the disclosure have been exemplified, other uses are contemplated. Therefore, the spirit and scope of the appended claims should not be limited to the description of the versions contained herein.

What is claimed is:

1. A multi-chambered wheel assembly comprising:
a wheel rim;
a tire mounted on the wheel rim, the tire and the wheel rim defining an interior chamber;
a divider wall disposed in the interior chamber, the divider wall defining a fill chamber and a gas cavity;
a gas valve communicated with the gas cavity, the gas valve configured to allow pressurized gas to be introduced into the gas cavity; and
a fill valve communicated with the fill chamber, the fill valve configured to allow fill material to be introduced into the fill chamber.

2. The multi-chambered wheel assembly of claim 1, wherein the fill chamber is at least partially filled with a non-compressible fill material.

3. The multi-chambered wheel assembly of claim 2, wherein the non-compressible fill material comprises a foam.

4. The multi-chambered wheel assembly of claim 2, wherein the non-compressible fill material comprises water.

5. The multi-chambered wheel assembly of claim 2, wherein the non-compressible fill material comprises solid pellets.

6. The multi-chambered wheel assembly of claim 2, wherein the fill chamber, being at least partially filled with the non-compressible fill material, includes a maximum fill chamber height that extends beyond the wheel rim in a radial direction such that the wheel assembly may include run-flat capabilities.

7. The multi-chambered wheel assembly of claim 1, wherein the divider wall comprises an inner tube sized for a tire smaller than the tire mounted on the wheel rim.

8. The multi-chambered wheel assembly of claim 1, wherein the divider wall is substantially rigid.

9. The multi-chambered wheel assembly of claim 1, in combination with an onboard inflation system for a vehicle having a plurality of multi-chambered wheel assemblies.

10. The multi-chambered wheel assembly of claim 9, wherein the onboard inflation system comprises at least one compressor configured to pump gas into the gas cavity of at least one of the plurality of multi-chambered wheel assemblies.

11. The multi-chambered wheel assembly of claim 10, wherein a release valve is configured to vent gas out of the gas cavity so that operating pressure in the gas cavity of each of the plurality of multi-chambered wheel assemblies can be lowered.

12. The multi-chambered wheel assembly of claim 10, wherein the onboard inflation system further comprises a controller configured to selectively control the at least one compressor to repeatedly change operating pressure in the gas cavity of at least one of the plurality of multi-chambered wheel assemblies between a lower inflation pressure and a higher inflation pressure.

13. The multi-chambered wheel assembly of claim 12, wherein the controller is further configured to selectively control the gas valve of at least one of the plurality of multi-chambered wheel assemblies.

14. A method of controlling inflation pressures of a plurality of tires mounted on a plurality of wheel rims of a vehicle, each tire being mounted on a respective wheel rim to define a wheel assembly, the method comprising:
(a) providing each wheel assembly with a fill chamber disposed in an interior chamber, each interior chamber defined by the tire and wheel rim of each respective wheel assembly, and a gas cavity operatively located in the interior chamber adjacent a tread portion of the tire;
(b) providing a compressor configured to introduce gas into the gas cavity of each respective wheel assembly;
(c) at least partially filling each fill chamber with a non-compressible fill material through a respective fill valve;
(d) providing each gas cavity with an initial inflation pressure greater than atmospheric pressure; and
(e) selectively operating the compressor to increase pressure in the gas cavity of each respective wheel assembly by pumping gas into the gas cavity through a gas valve, thereby more rapidly providing an increased pressure than the compressor could do if each respective wheel assembly did not include the interior chamber partially occupied by the fill chamber at least partially filled with the non-compressible fill material.

15. The method of claim 14, further comprising:
selectively venting at least one wheel assembly to allow gas to escape the associated gas cavity to decrease pressure in the gas cavity, thereby more rapidly providing a decreased pressure than possible if each respective wheel assembly did not include the interior chamber partially occupied by the fill chamber at least partially filled with the non-compressible fill material.

16. The method of claim 14, wherein:
step (e) is performed by an automatic controller in response to an operator input.

17. The method of claim 14, further comprising:
removing at least some of the non-compressible fill material from the fill chamber through the fill valve of the wheel assembly; and
removing the tire from the wheel rim for service or replacement.
